(19) United States
(12) Patent Application Publication
(10) Pub. No.: US 2006/0264308 A1
(43) Pub. Date: Nov. 23, 2006

(54) Method and device for producing packing coverings for composite cardboard/plastic packages

(75) Inventors: Matthias Dammers, Alsdorf (DE); Peter Ripphausen, Eschweiler (DE)

Correspondence Address: THE WEBB LAW FIRM, P.C., 700 KOPPERS BUILDING, 436 SEVENTH AVENUE, PITTSBURGH, PA, 15219, US

(73) Assignee: SIG Technolohy Ltd., Neuhaussen am Rheinfall (CH)

(21) Appl. No.: 10/559,100

(22) PCT Filed: Jun. 7, 2004
(86) PCT No.: PCT/EP04/06107

§ 371 Date: May 24, 2006

(30) Foreign Application Priority Data
Jun. 6, 2003 (DE) 10326.106.0

(51) Int. Cl. B31B 1/00

(52) U.S. Cl. 493/51

(57) ABSTRACT

The invention is directed to novel packages and to a method and device for producing packing coverings for composite cardboard/plastic packages. Specifically, beverage packages that include an opening for pouring and/or removing the product contained therein. The method incorporates a reliable solution to prevent contact between the contained product and the raw cardboard material in an area proximate to the opening during storage, after the package is opened for the first time, and after resealing of the opening. In variations of the package and its method of making, the cardboard is punched with an opening defined by a circular edge. The edge and the raw cardboard are coated with a plastic material, and a smaller pour opening is centrally punched inside the punched opening leaving the circular edge sealed by the plastic coating. The package is then creased, seamed, folded, and than later sterilized, filled, and sealed.

The present invention relates to a method for manufacturing packing coverings for cardboard/plastic compound packing fitted with an opening aid, whereby at first packing covering is manufactured by the following steps:
punching out openings in the raw cardboard material in the region of the afterward pour openings,
double-sided coating of the raw cardboard material with a plastic layer and creasing of the compound material,
punching out pour openings in the region of the coated openings of the compound material, in which the pour openings are smaller than the punched openings,
decollating of the compound material in blanks and
sealing the longitudinal seam (L) into a packing covering (M)

Beverage packings made of cardboard/plastic-compound material have been known for many years and are available on the market in a multitude of shapes and configurations. For better opening and often also for resealing beverage packings frequently have an opening aid, enabling the packing to be opened for removing the products it contains at a predetermined point and where required to be resealed.

Such beverage packings are produced either by the so-called tube-forming method from an endless length of compound material, or from individual blanks previously cut to length. EP 0 558 916 B1 for example discloses stamping out a recess, which is then sealed tight again with a tear-off tab, in the length of packing material or a blank in the vicinity of the afterward pour opening. Alternatively or in addition these opening can also be provided further with a reclosable pouring element.

The material used for such packings comprises raw cardboard, whose the inner and outer surfaces are coated with a thin plastic layer, mostly PE film. In this way such packing is on the one hand protected adequately against external influences such as moisture or dust, and on the other hand also the product contained therein is separated hygienically and cleanly from the raw cardboard material. Furthermore, the surface can be permanently printed. In the region of the openings however the compound material is punched through, such that the product can come into contact with the raw cardboard as it pours out. This can on the one hand result in contamination of the product, and on the other hand can also lead to the cardboard being softened by the soaked-up liquid.

These openings are closed outwardly by the tear-off tab or pour element to be sealed and thus the product is protected reliably from external influences such as moisture, light, extraneous aromas or the like. In order to also offer corresponding inwards protection it is necessary to close off the compound material in the region of the eventual pour opening again with a section of PE film or the like, to reliably exclude the above described when the product makes contact with the raw cardboard. This is expensive, because a correspondingly structured additional procedural step is required in the manufacturing process. Once such packings are opened, however, when the product is poured out the open edge of the raw cardboard, which encloses the pour opening, again is in contact with the product, resulting in the abovedescribed disadvantages.

The object of the invention therefore is to provide a method for manufacturing packing coverings for cardboard/plastic-compound packings provided with an opening aid, in which a reliable protection against germs being in the region of the pour opening is warranted and in which also after the packing is first opened there is no contact between raw cardboard material and product in the region of the pour opening.

This task is solved according to the invention in that not only the inside of the packing is sterilised but also the pour opening is sterilised from the outside before filling and sealing of the finished packing and that a sterile tear-off tab and/or a resealable pour element is applied to the pour opening.

A packing covering produced according to the inventive method is characterised in that the raw cardboard material around the punched opening is fully coated in plastic.

To manufacture a finished beverage packing use of the abovementioned packing covering provides that prior to filling and sealing of the finished packing not only the packing interior, but also the pour opening are sterilised from the exterior, and that a sterile tear-off tab and/or a resealable pour element is applied to the pour opening.

A further teaching of the invention provides for the sterile tear-off tab is cut to length after sealing on the packing.

The invention will now be explained in greater detail hereinbelow by means of diagram illustrating a preferred embodiment, in which:

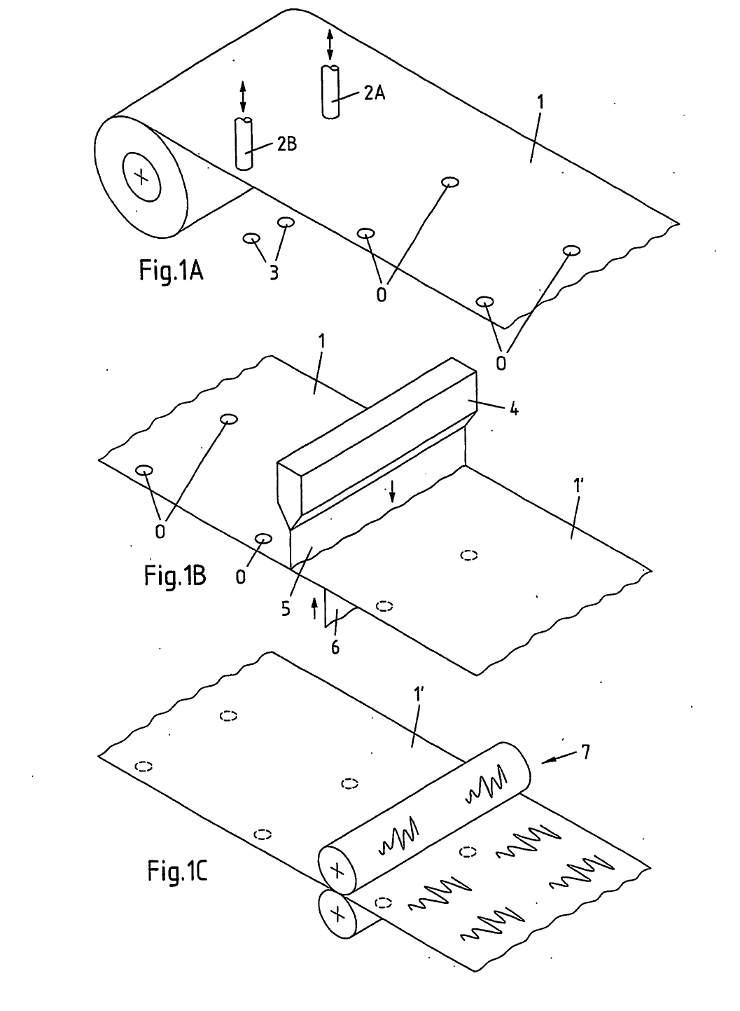

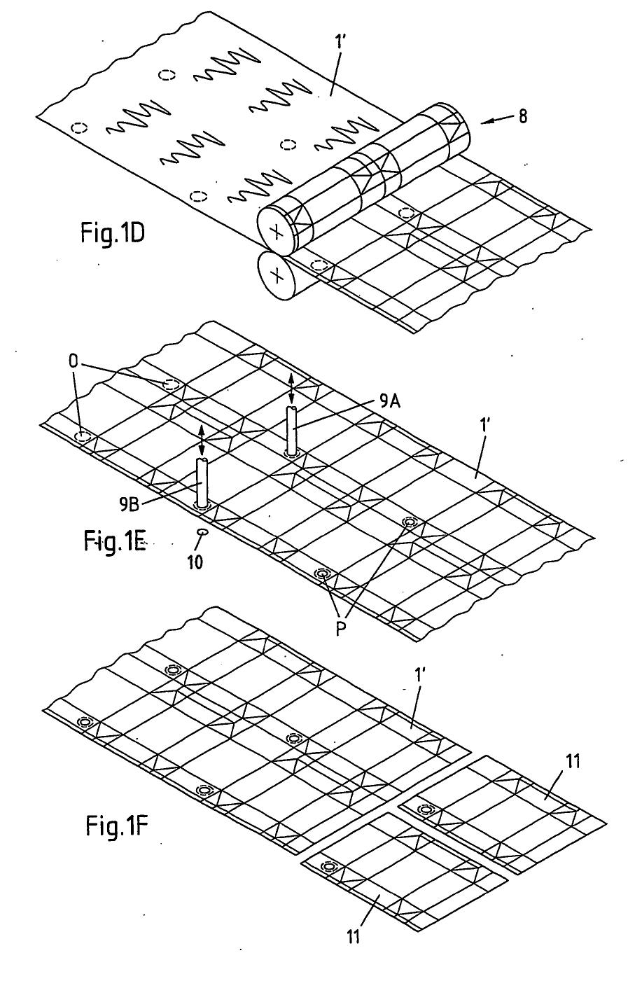

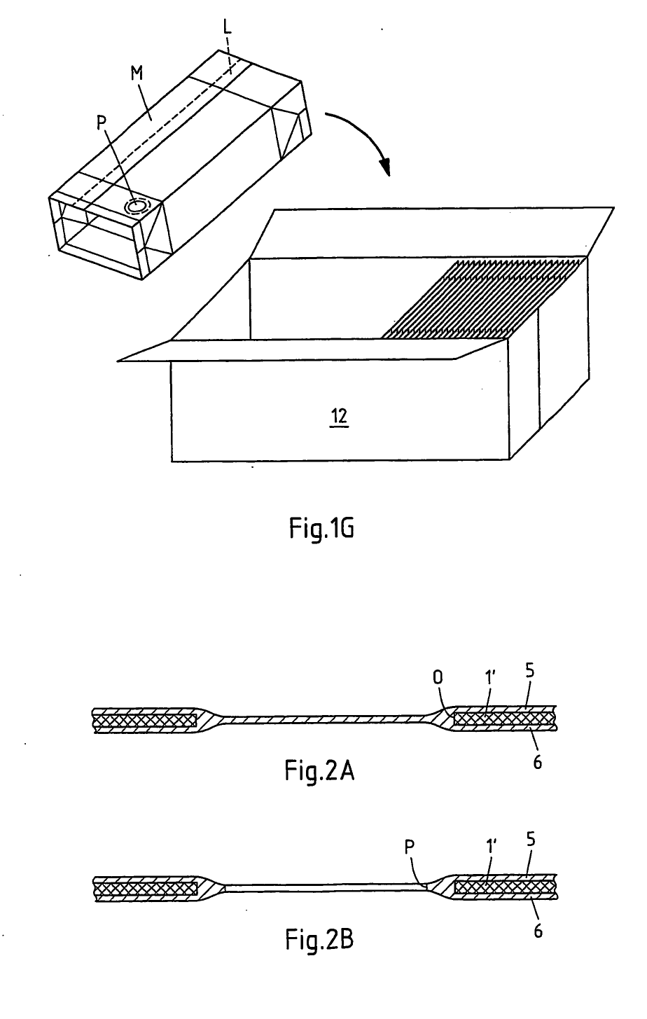

FIGS. 1A to 1G show the individual procedural steps for manufacturing the inventive packing coverings, schematically and in perspective,

FIG. 2A shows a cross-section through a coated pour opening in the compound material,

FIG. 2B shows a cross-section through a punched coated pour opening in the compound material, and

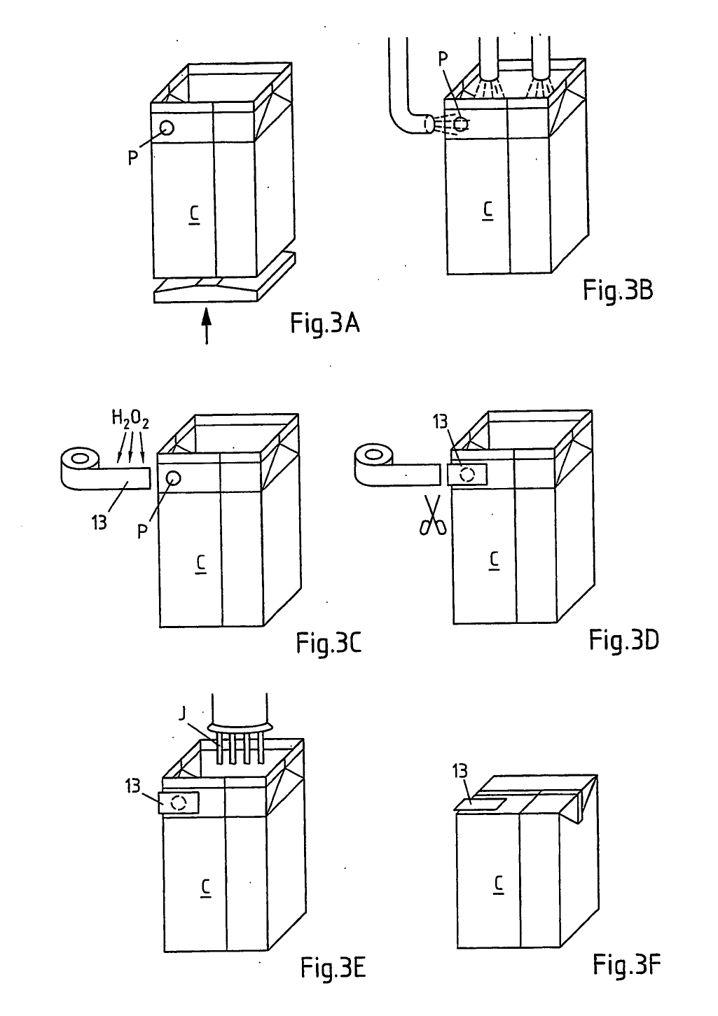

FIGS. 3A to 3F show the procedurel steps for manufacturing a finished filled beverage packing from a packing covering produced according to the present invention, schematically and in perspective.

The sequence of the inventive manufacturing procedure is illustrated strongly diagrammatically in FIGS. 1A to 1G. A length of raw cardboard 1 wound on a roll is first sent to a punch, in which openings O are stamped out in the region of the afterward pour openings of the beverage carton to be produced. FIG. 2A shows the length of raw cardboard material 1 as it passes through the punch, of which only two punch dies 2A and 2B are illustrated, which ensure regular production of the openings O. At this point cardboard slugs 3 are created as punched waste and must be properly removed.

Next the length of raw cardboard material 1 is fed to a coating plant. In a first unit the first surface of the length 1 is coated with a plastic film. Such a unit can also be used to coextrude another film, for example aluminium film. FIG. 1B schematically shows how the produced openings O are coated. This illustrates a liquid plastic film 5, which is applied to a surface of the moved length 1 from a first extruder unit 4. After the length is reversed corresponding treatment of the second surface takes place by a second extruder unit. There the other surface is coated with a plastic film 6, which is pictured here only from below for the sake of clearer viewing.

The length of cardboard/plastic compound material 1′, now coated on both sides, is then sent to a printing unit 7, where print according to the desired print pattern of the afterward packing is applied, as shown schematically in FIG. 1C. Printing of the coated exterior of the compound material is preferred, though it is also possible to already print the raw cardboard prior to coating. Next comes the creasing and punch unit 8, in which the crease and fold lines required to form the packing are made. FIG. 1D schematically illustrates how, by means of a rotary die cutter, the length 1′ is provided with the crease and fold lines necessary for forming the packing, not illustrated in greater detail here.

As shown in FIG. 1E, the correspondingly treated length 1′ is now forwarded to another punch, not shown, where punch dies 9A and 9B produce the final pour openings P in the region of the already coated openings O. At this point corresponding film waste 10 results, which again is accordingly disposed of.

FIG. 1F shows how individual blanks 11 are manufactured from the length of compound material 1′.

FIG. 1G finally schematically illustrates that the decollated blanks 11 are sealed along their longitudinal seam L and are stacked folded flat in a carton 12. The packing coverings M manufactured and packaged in this manner are then transported to the actual filling plants.

For better overview FIG. 2A once again shows a cross-section of a coated opening O in the carton material 1, which is coated on its upper and lower surface with a plastic layer 5 and 6 in each case. It is clearly transparent that both plastic layers 5 and 6 form a single plastic film in the region of the openings O. In the process the carton edges of the openings O are sealed completely with plastic material.

FIG. 2B shows a pour opening P punched in a coated opening O in cross-section. Because the pour opening P is smaller than the punched opening O the product coming through the pour opening cannot come into contact with the carton edges of the openings O.

Finally, for the sake of completion, FIGS. 3A to 3F schematically illustrate how finished beverage packings are made from the packing coverings M. In FIG. 3A first the floor is formed and the packing C is sealed on the floor side. FIG. 3B schematically shows the sterilisation procedure of the packing C from inside, whereby the region on the pour opening P is also sterilised from outside. FIG. 3C schematically shows the feeding of a sterile tear-off tab 13, which is then cut to length on the packing C after sealing, as shown in FIG. 3D. In this way the pour opening P is reliably sealed.

It is understood, even if not illustrated, that the pour openings P near the tear-off tab 13 can still also be provided with a resealable pour element, or alternatively to this.

Finally, in FIG. 3E the filling procedure is shown schematically, whereby the internally sterilised container is filled with the product J to be packed. After the packing C is sealed shut complete production of the ready-for-sale beverage packing is complete, as indicated in FIG. 3F.

1-3. (canceled)

4. A method for manufacturing a finished beverage packing formed from a creased packing covering incorporating a compound material that includes a raw cardboard material having at least one punched opening defined by a circular edge and being interiorly and exteriorly coated with a plastic layer that covers the cardboard material and the circular edge, the creased packing covering being further adapted with at least one pour opening of a smaller diameter and generally centered about the punched opening, comprising the steps of:
punching out openings to define respective circular edges in the raw cardboard material in a region of afterward pour openings;
coating interior and exterior sides of the raw cardboard material with a plastic layer to establish the compound material and to cover the circular edges;
creasing the compound material;
punching out pour openings with smaller diameters and to be generally centered about the circular edges;
decollating blanks from the compound material; and
sealing a longitudinal seam to form the packing covering.

5. The method according to claim 4, further comprising the step of:
forming a sealed floor in the packing covering;
sterilizing the interior of the packing covering and the exterior of the pour opening prior to filling and sealing of the finished package; and
sealing the pour opening with a sterile tear-off tab.

6. The method according to claim 5, further comprising the step of:
cutting the sterile tear-off tab to a length.

7. The method according to claim 4, further comprising the step of:
forming a sealed floor in the packing covering;
sterilizing the interior of the packing covering and the exterior of the pour opening prior to filling and sealing of the finished package; and
sealing the pour opening with a resealable pour element.

8. The method according to claim 7, further comprising the step of:
cutting the resealable pour element to a length.

9. A finished beverage packing, comprising:
a raw cardboard material adapted with at least one punched opening defined by a circular edge in the raw cardboard material proximate to a pour region;
a compound material formed from a plastic coating covering the circular edge and each side of the raw cardboard material; and
a pour opening defined with a smaller diameter and generally centered about the circular edge.

10. The finished beverage package according to claim 9, further comprising:
a crease pattern formed about the compound material.

11. The finished beverage package according to claim 10, further comprising:
laterally spaced apart longitudinal edges defined in the compound material.

12. The finished beverage package according to claim 11, further comprising:
a longitudinal seam joining the longitudinal edges to establish a packing covering.

13. The finished beverage package according to claim 12, further comprising:
a seam sealingly formed to establish a floor of the packing covering.

14. The finished beverage package according to claim 13, further comprising:
a sterile tear-off tab cut to a length and sealing the pour opening.

15. The finished beverage package according to claim 14, further comprising:
a resealable pour element cut to a length and sealing the pour opening.
